(19) United States
(12) Patent Application Publication
(10) Pub. No.: US 2015/0190871 A1
(43) Pub. Date: Jul. 9, 2015

(54) Saw Blade Having Compound Angled Tips

(71) Applicant: Simonds International L.L.C., Fitchburg, MA (US)

(72) Inventor: Jeremy Dexter, Templeton, MA (US)

(21) Appl. No.: 14/590,598

(22) Filed: Jan. 6, 2015

Related U.S. Application Data
(60) Provisional application No. 61/925,323, filed on Jan. 9, 2014.

(51) Int. Cl. B23D 61/12

(52) U.S. Cl. CPC B23D 61/121

(57) ABSTRACT

A saw blade is configured with groupings of teeth that include a raker tooth, a left set toot, and a right set tooth. During a manufacturing procedure, a manufacturer creates the cutting surfaces in each of the teeth following a setting process. For example, for each of the right and left set teeth, the manufacturer forms a lateral contact portion, a back portion, and a medial dress angle portion. Additionally, the manufacturer forms first and second side angle portions in each non-set tooth. In use, the tooth form pattern of teeth can provide a substantially smooth finish to a work piece.

### RELATED APPLICATIONS

This patent application claims the benefit of U.S. Provisional Application No. 61/925,323, filed on Jan. 9, 2014, entitled, “Saw Blade Having Angled Tip Elements,” the contents and teachings of which are hereby incorporated by reference in their entirety.

### BACKGROUND

Conventional saw blades, such as bandsaw blades, are utilized to cut materials to a desired size. During a cutting procedure, material is removed by a series of teeth formed into one edge of the saw blade. In certain bandsaw blades, in a process known as setting, some of the teeth are bent in a direction normal to a midplane of the saw blade. During setting, the bent teeth may be arranged in recurring patterns, usually beginning with a non-bent tooth, often referred to as a raker tooth, and followed by alternately bent teeth. When the combination of a non-bent raker tooth and alternately bent set teeth pass through a work piece, the tooth points remove material and create a slot or kerf that is wider than a thickness of the blade for passage of the bandsaw blade there through.

To enhance the performance of conventional saw blades, each tooth of the saw blade can be manufactured from a material that is relatively harder than the saw blade body material, such as tungsten carbide. During a manufacturing procedure, a manufacturer brazes a volume of tungsten carbide to a tip portion of each tooth of a saw blade body. To shape the tungsten carbide into a tooth point, the manufacturer grinds the sides of the tungsten carbide volume until these sides are parallel to the sides of the saw blade body. The manufacturer then grinds a face portion and a back portion of the tungsten carbide to form a tooth point. As indicated in FIG. 1, following the shaping process, the manufacturer sets a number of teeth on the saw blade as either right-set 12 or left-set teeth 14, resulting in a saw blade 10 having a set tooth pattern.

### SUMMARY

Conventional saw blades are prone to manufacturing variability. For example, during manufacturing of conventional tungsten carbide tipped saw blades, manufacturers braze tungsten carbide material to a saw blade body and grind excess material from the material to create each saw blade tooth. Manufacturers perform this grinding process prior to setting the teeth on the saw blade. Accordingly, with reference to FIG. 1, during a cutting procedure, the corner portions 16, 18 of the right and left set teeth 12, 14, respectively, engage a work piece and, based upon the accuracy and repeatability of the tooth setting process, can provide a relatively rough surface finish to the work piece.

By contrast to conventional saw blades, embodiments of the present innovation relate to a saw blade having compound angled tips. In one arrangement, a manufacturer brazes a volume of material, such as tungsten carbide, to a saw blade body and performs a setting procedure on a subset of the teeth to position the subset of teeth at either a right or left set angle relative to a longitudinal axis of the saw blade body. The manufacturer then removes a portion of the volume of material on each set tooth, such as via a grinding procedure, to form a cutting element having a face portion, a lateral contact portion, a back portion, and a medial dress angle portion. As a result of the grinding procedure, the lateral contact portion of the cutting element for each of the right and left set teeth includes a contact face which is angled relative to the longitudinal axis of the saw blade body and that opposes the set angle of the tooth. With such a configuration, the lateral contact portion for each set tooth is configured with a compound angle geometry. In use, with the compound angle geometry, as the upper corners of the lateral contact portions of the right and left set teeth contact the side walls of a work piece, the teeth provide a substantially smooth finish to the work piece.

In one arrangement, a saw blade comprises a saw blade body and at least one raker tooth carried by the saw blade body, the at least one raker tooth having a longitudinal axis that is substantially aligned with a longitudinal axis of the saw blade body. The saw blade body comprises at least one set tooth carried by the saw blade body, the at least one set tooth defining a set angle along a first direction relative to the longitudinal axis of the saw blade body. The saw blade body comprises a cutting element carried by the at least one set tooth, the cutting element defining a lateral contact portion having a contact face defining a face angle along a second direction relative to the longitudinal axis of the saw blade body, the second direction opposing the first direction. The angle of the contact face is less than the set angle of the at least one set tooth.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates an end view of a prior art saw blade.

FIG. 2 illustrates a perspective view of a saw blade, according to one arrangement.

FIG. 4 illustrates a top view of a saw blade during a manufacturing process, according to one arrangement.

FIG. 5 illustrates a side view of the saw blade of FIG. 4.

FIG. 6A illustrates an end view of a left set tooth and cutting element, according to one arrangement.

FIG. 6B illustrates an end view of a right set tooth and cutting element, according to one arrangement.

FIG. 6C illustrates an end view of a raker tooth and cutting element, according to one arrangement.

FIG. 7 illustrates a top view of the teeth of the saw blade of FIG. 2, according to one arrangement.

FIG. 8 illustrates an end view of the right set tooth, left set tooth, and raker tooth of FIGS. 6A-6C, according to one arrangement.

FIG. 9A illustrates an end view of a left set tooth and cutting element, according to one arrangement.

FIG. 9B illustrates an end view of a right set tooth and cutting element, according to one arrangement.

FIG. 9C illustrates an end view of a raker tooth and cutting element, according to one arrangement.

FIG. 10 illustrates a perspective view of a saw blade, according to one arrangement.

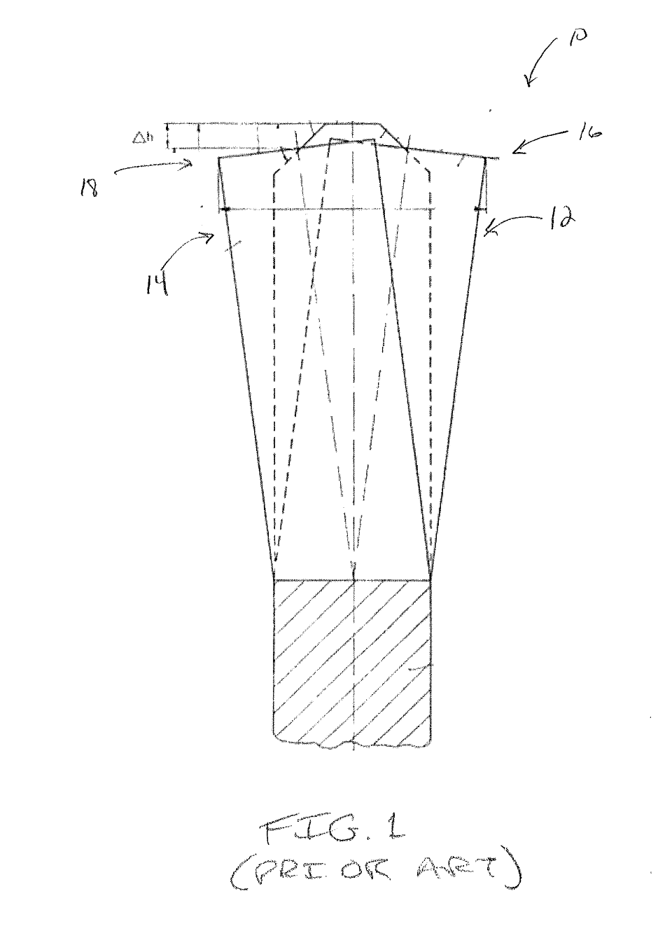

### DETAILED DESCRIPTION

A saw blade is configured with groupings of teeth that include a raker tooth, a left set toot, and a right set tooth. During a manufacturing procedure, a manufacturer brazes a volume of material, such as tungsten carbide, to a saw blade body and performs a setting procedure on a subset of the teeth to position the subset of teeth at either a right or left set angle relative to a longitudinal axis of the saw blade body. The manufacturer then removes a portion of the volume of material on each set tooth, such as via a grinding procedure, to form a cutting element having a face portion, a lateral contact portion, a back portion, and a medial dress angle portion. As a result of the grinding procedure, the lateral contact portion of the cutting element for each of the right and left set teeth includes a contact face which is angled relative to the longitudinal axis of the saw blade body and that opposes the set angle of the tooth. With such a configuration, the lateral contact portion for each set tooth is configured with a compound angle geometry. In use, with the compound angle geometry, as the upper corners of the lateral contact portions of the right and left set teeth contact the side walls of a work piece, the teeth provide a substantially smooth finish to the work piece.

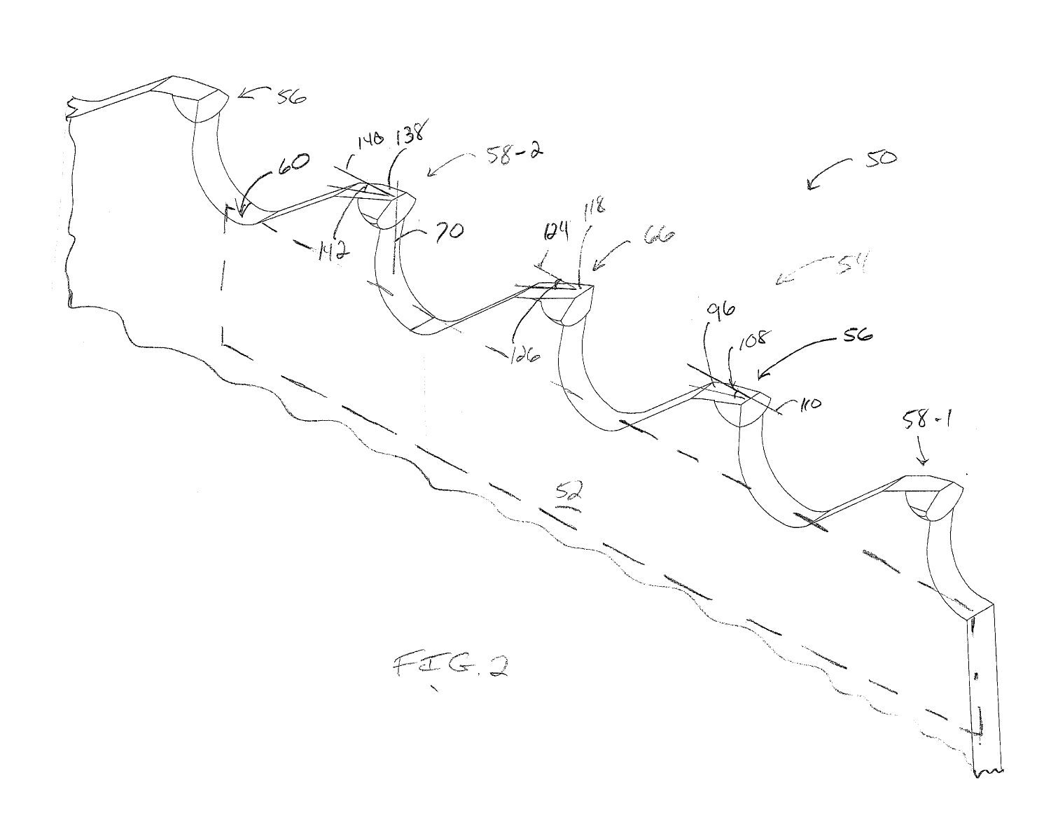

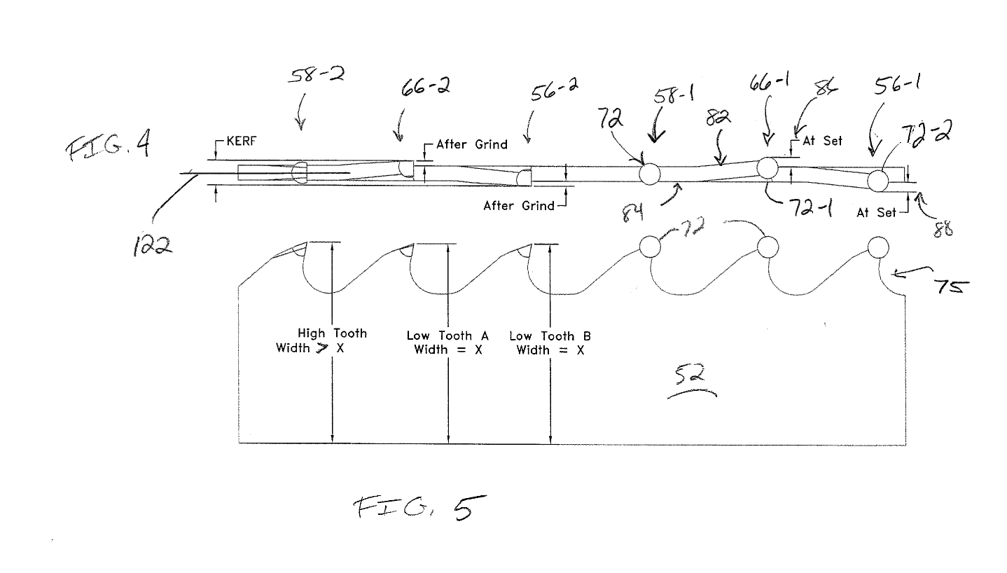

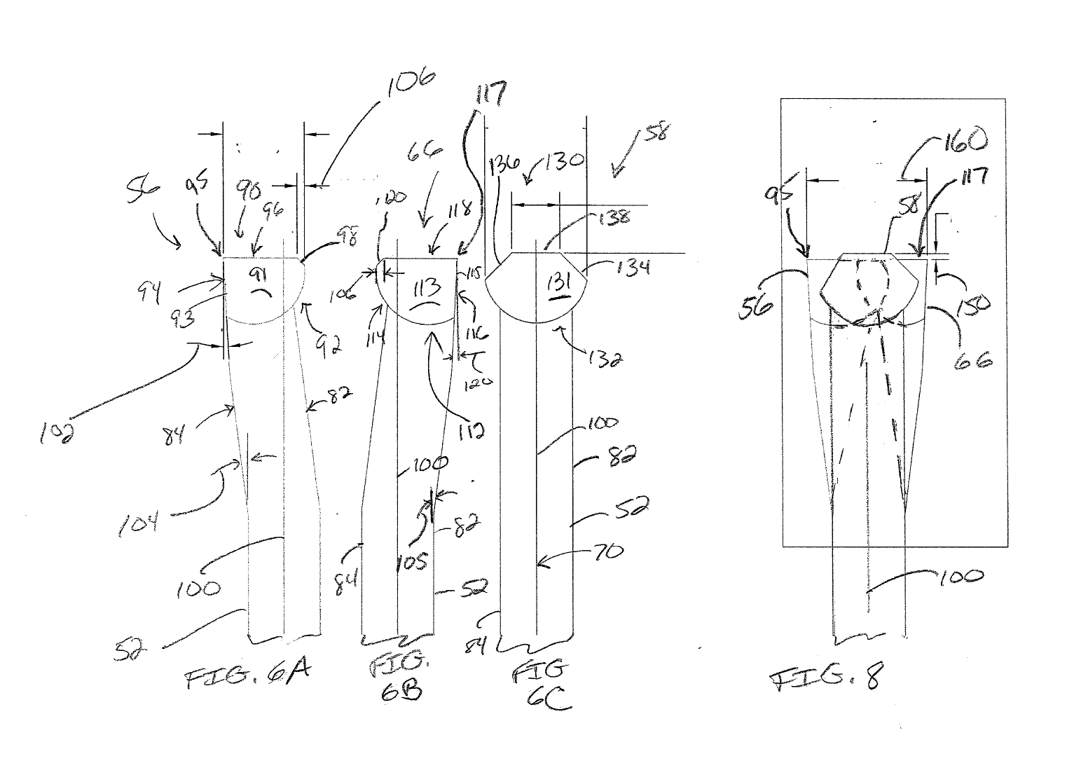

FIG. 2 illustrates a saw blade 50, such as a bandsaw blade, according to one arrangement. The saw blade 50 includes a saw blade body or band 52 and a group of teeth 54 disposed on the saw blade body 52. As illustrated, the group of teeth 54 includes set teeth 56, 66 and a non-set tooth 58, referred to as a raker tooth herein. The set teeth 56, 66 are disposed on the saw blade body 52 in a respective set direction relative to a midplane 60 of the saw blade body 52. For example, with reference to FIGS. 6A-6C, a left set tooth 56 is bent toward a first or left lateral side of the saw blade body 52 relative to the midplane 60 at an angle 104 of between about 5° and 15° relative to a longitudinal axis or centerline 100 of the saw blade body 52 and a right set tooth 66 is set or bent toward second or right lateral side of the saw blade body 52 relative to the midplane 60 at an angle 105 of between about 5° and 15° relative to the longitudinal axis 100. The raker tooth 58, by contrast, has a longitudinal axis 70 that is substantially collinear with the longitudinal axis 100 of the saw blade body 52.

Each tooth 56, 58, 66 includes a cutting element, at least a portion of which is configured to contact a portion of a work piece during a cutting procedure. As will be described below, a manufacturer forms the geometry of each cutting element for each tooth 56, 58, 66 following the setting of teeth 56, 66.

During a manufacturing process, a manufacturer first prepares a saw blade body or backer 52, as illustrated in FIGS. 3 through 5. With reference to FIG. 3, the saw blade body 52 includes a set of tooth blanks 75, each defining a receptacle 80 configured to receive a material having a high hardness relative to the hardness of the saw blade body 52. For example, the material of the saw blade body 52 can have a Rockwell hardness of between about 43 and 55 while the material of the cutting elements can have a Rockwell hardness that is greater than about 60. While the tooth blanks 75 can be disposed on the saw blade body 52 in a variety of ways, in one arrangement, the tooth blanks 75 are disposed at a variable pitch for a given toothform pattern.

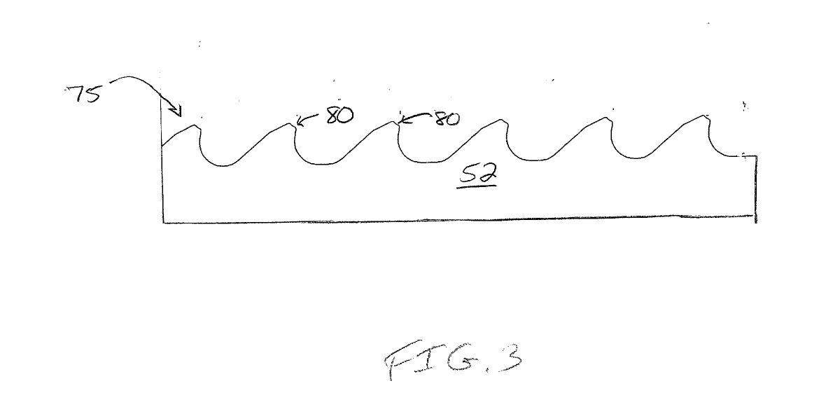

With reference to FIGS. 4 and 5, the manufacturer then brazes a volume of relatively high hardness material 72, such as volume of tungsten carbide, to the receptacle 80. As illustrated in FIG. 4, the volume of material 72 can define a substantially spherical geometry. However, the volume of material 72 can also define a substantially cylindrical shape which includes a lateral axis that extends along a lateral axis 122 of the saw blade 50.

Next, the manufacturer sets particular teeth of the group of teeth 54. For example, with particular reference to FIG. 4, the manufacturer sets tooth 66-1 as a right set tooth, sets tooth 56-1 as a left set tooth, and maintains tooth 58-1 as an unset or raker tooth. With such setting, a portion of each volume of material 72 extends a distance beyond a side face of the saw blade body 52. For example, a portion of the volume of material 72-1 of the right set tooth 66-1 extends a first distance 86 from a first side 82 of the saw blade body 52 and a portion of the volume of material 72-2 of the left set tooth 56-1 extends a second distance 88 from a second side 84 of the saw blade body 52. While the distances 86, 88 can be configured with a variety of values, in one arrangement, each distance 86, 88 is between about 0.035 and 0.039 inches.

Following the setting procedure, the manufacturer then shapes each volume of material 72 into a cutting element having a particular geometry. While the cutting element can be shaped using a variety of techniques, in one arrangement, the manufacturer grinds each volume 72 to generate the cutting element geometry.

With reference to FIG. 6A, following a shaping procedure, the left set tooth 56 includes a cutting element 90 having a face portion 91, a base portion 92, a left lateral contact portion 94, a back portion 96, and a medial dress angle portion 98. As illustrated, the base portion 92 extends beyond a first side 82 of the saw blade body 52 and is configured with a substantially spherical or cylindrical geometry. The left lateral contact portion 94 is configured with a contact face 93 which is angled relative to the longitudinal axis 100 of the saw blade body 52.

For example, with continued reference to FIG. 6A, the contact face 93 defines a face angle 102 relative to the longitudinal axis 100 of the saw blade body 52. While the contact face 93 can be shaped with a variety of angles, the contact face 93 can be disposed at an angle 102 of between about 2° and 8° relative to the longitudinal axis 100 of the saw blade body 52 and, in one arrangement, is disposed at an angle of about 3° relative to the longitudinal axis 100. Accordingly, the angle 102 of the contact face 93 (e.g., between about 2° and 8°.) is less than the set angle 104 of the left set tooth 56 (e.g., between about 5° and 15°).

As illustrated, the face angle 102 extends along a direction that is substantially opposite to the direction of set angle 104 of the set tooth 56. For example, after the setting procedure, the set tooth 56 is disposed in a first, left direction away from the longitudinal axis 100 of the saw blade body 52. By contrast, after the shaping procedure, the contact face 93 is disposed in a second direction toward the longitudinal axis 100 of the saw blade body 52. Accordingly, the angles 102 and 104 of the tooth 56 and the contact face 93, respectively, define a compound angle for the left set tooth 56.

Further, the contact face 93 of the left lateral contact portion 94 is angled relative to the lateral axis 122 of the saw blade body 52. For example, with reference to FIG. 7, the contact face 93 defines a face angle 105 of between about 2° and 8° relative to the lateral axis 122 of the saw blade body 52.

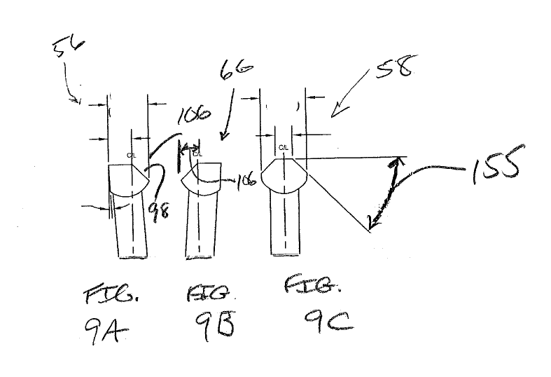

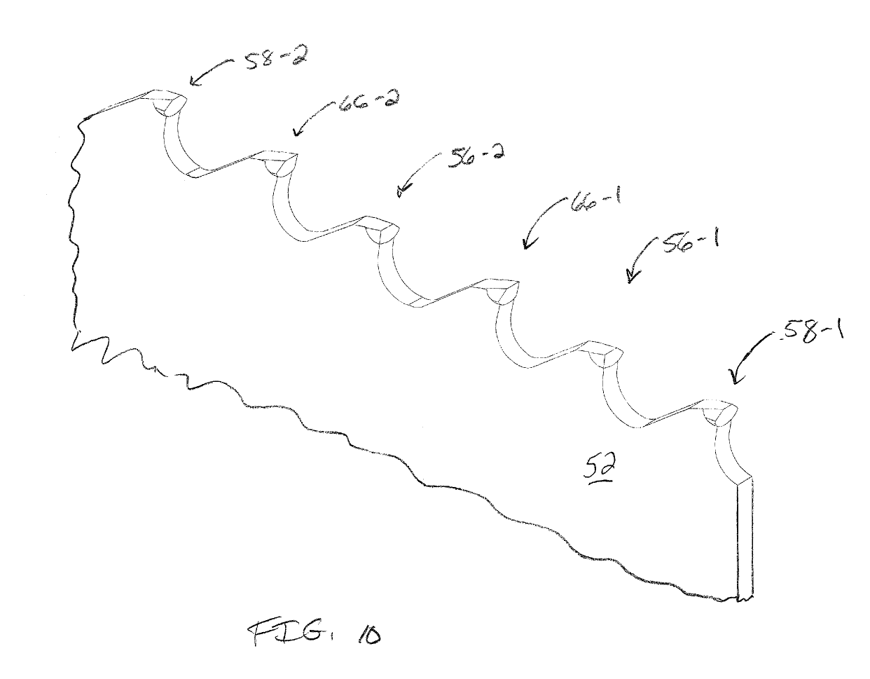

The medial dress angle portion 98 is configured to limit the horizontal width of the cutting element 90 in order to minimize contact between a medial portion of the set tooth 56 and a work piece. For example, the medial dress angle portion 98 is configured as a chamfer along an upper corner of the left set tooth 56. In one arrangement, the medial dress angle portion 98 is configured with a relatively minimal length 106, such as a length of about 0.006 inches. Alternately, as illustrated in FIG. 9A, the medial angle portion 98 is configured with a relatively large length 106, such as a length of about 0.030 inches. The length of the medial angle dress portion 98 can dependent upon the set angle 102 of the left set tooth 104. For example, the medial dress angle portion 98 can have a relatively minimal length 106 (FIG. 6A) for a set tooth 56 having a relatively large set angle 104 and can have a relatively large length 106 (FIG. 9A) for a set tooth 56 having a relatively small set angle 104.

The back portion 96, as illustrated in FIG. 2, is configured with a taper along a longitudinal axis 110 of the left set tooth 56. For example, the back portion 96 can define an angle 108 between about 0° and 5° relative to the longitudinal axis 110 of the left set tooth 56 and, in one arrangement, is disposed at an angle of about 3° relative to the longitudinal axis 110.

With reference to FIG. 6B, also following the shaping procedure, the right set tooth 66 includes a cutting element 112 having a face portion 113, a base portion 114, a right lateral contact portion 116, a back portion 118, and a medial dress angle portion 120. As illustrated, the base portion 114 extends beyond a second side 84 of the saw blade body 52 and is configured with a substantially spherical or cylindrical geometry. The right lateral contact portion 116 is configured with a contact face 115 which is angled relative to the longitudinal axis 100 of the saw blade body 52

For example, with continued reference to FIG. 6B, the contact face 115 defines a face angle 120 relative to the longitudinal axis 100 of the saw blade body 52. While the contact face 115 can be shaped with a variety of angles, the contact face 115 can be disposed at an angle 120 of between about 2° and 8° relative to the longitudinal axis 100 of the saw blade body 52 and, in one arrangement, is disposed at an angle of about 3° relative to the longitudinal axis 100. Accordingly, the angle 120 of the contact face 115 (e.g., between about 2° and 8°) is less than a set angle 105 of the right set tooth 56 (e.g., between about 5° and 15°).

As illustrated, the face angle 120 extends along a direction that is substantially opposite to the direction of set angle 105 of the set tooth 66. For example, after the setting procedure, the set tooth 66 is disposed in a first, right direction away from the longitudinal axis 100 of the saw blade body 52. By contrast, after the shaping procedure, the contact face 93 is disposed in a second direction toward the longitudinal axis 100 of the saw blade body 52. Accordingly, the angles 105 and 120 of the tooth 56 and the contact face 93, respectively, define a compound angle for the right set tooth 66.

Further, the contact face 115 of the right lateral contact portion 116 is angled relative to the lateral axis 122 of the saw blade body 52. For example, with reference to FIG. 7, the contact face 115 defines a face angle 107 of between about 2° and 8° relative to the lateral axis 122 of the saw blade body 52.

Returning to FIG. 6B, the medial dress angle portion 120 is configured to limit the horizontal width of the cutting element 112 in order to minimize contact between a medial portion of the set tooth 66 and a work piece. For example, the medial dress angle portion 120 is configured as a chamfer along an upper corner of the right set tooth 66. In one arrangement, the medial dress angle portion 120 is configured with a relatively minimal length 106, such as a length of about 0.006 inches. Alternately, as illustrated in FIG. 9B, the medial dress angle portion 120 is configured with a relatively large length 106, such as a length of about 0.030 inches.

The back portion 118, as illustrated in FIG. 2, is configured with a taper along a longitudinal axis 124 of the right set tooth 66. For example, the back portion 118 can define an angle 126 between about 0° and 5° relative to the longitudinal axis 124 of the right set tooth 56 and, in one arrangement, is disposed at an angle of about 3° relative to the longitudinal axis 124.

Also following a shaping procedure, with reference to FIG. 6C, the raker tooth 58 includes a cutting element 130 having a face portion 131, a base portion 132, a first side angle portion 134, a second side angle portion 136, and a back portion 138. As illustrated, the base portion 132 extends beyond the first side 82 and the second side 84 of the saw blade body 52 and is configured with a substantially spherical or cylindrical geometry. The first and second side angle portions 134, 136 are configured as chamfers along the respective upper corners of the cutting element 130. For example, with reference to FIG. 9C, the first and second side angle portions 134, 136 define respective angles 155 relative to the back portion 138, such as angles of between about 40° and 55°.

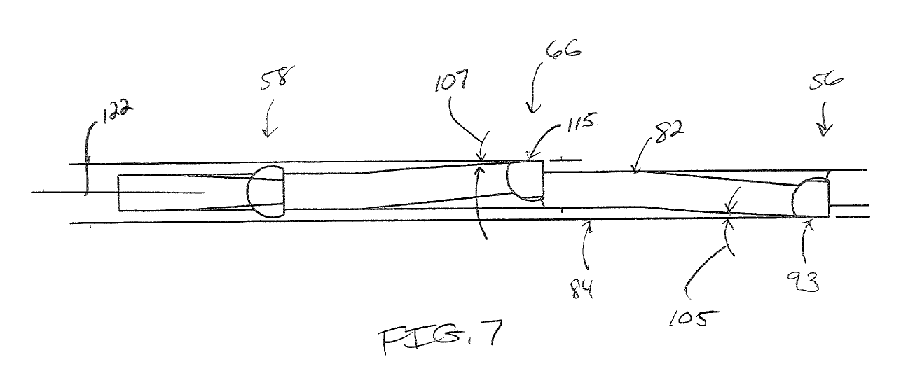

The back portion 138, as illustrated in FIG. 2, is configured with a taper along a longitudinal axis 140 of the raker tooth 58. For example, the back portion 138 can define an angle 142 between about 0° and 5° relative to the longitudinal axis 140 of the raker tooth 58 and, in one arrangement, is disposed at an angle of about 3° relative to the longitudinal axis 142. Additionally, with reference to FIGS. 5 and 8, the back portion 138 can be disposed at a distance 150 above the back portions 96, 118 of the left and right set teeth 56, 66, respectively, such as a distance of between about 0.000 inches and 0.010 inches.

FIG. 8 illustrates an overlay of the left set, right set, and raker teeth 56, 66, 58 of the saw blade 50. As indicated above, each of the left and right set teeth 56, 66 are configured with a compound angle: the angles 102 and 104 of the tooth 56 and the contact face 93, respectively, define a compound angle for the left set tooth 56 and the angles 105 and 120 of the tooth 66 and the contact face 115, respectively, define a compound angle for the right set tooth 56.

The compound angles disposes the corners or cutting elements 95, 117 of the set teeth 56, 66 proud relative to the raker tooth 58, which allows the saw blade 52 to generate a relatively larger kerf 160, compared to conventional saw blades, without requiring an increase in the side clearance at the cutting elements 95, 117. Further, the compound angle associated with each set tooth 56, 66 substantially isolates the cutting force on the cutting elements 95, 117 during a cutting procedure, and minimizes the amount of force received by the saw blade body 52. Accordingly, the relatively large angles 104, 105 of the set teeth 56, 66 provides the saw blade 50 with relatively high rigidity while the relatively small angles 102, 120 of the contact faces 93, 115 configures the saw blade 50 to generate a substantially smooth finish on a work piece.

As illustrated in FIG. 2, the saw blade 50 is configured with left and right set teeth 56, 66 disposed between adjacent raker teeth 58-1, 58-2. Such illustration is by way of example only. In one arrangement, the saw blade 50 can include a number of left and right set teeth 56, 66 disposed between adjacent raker teeth 58-1, 58-2. For example, FIG. 10 illustrates a portion of a saw blade having a first raker tooth 58-1, first left and right set teeth 56-1, 66-1, second left and right set teeth 56-2, 66-2, and a second raker tooth 58-2. As indicated above, the set teeth undergo the setting procedure, and the respective cutting elements undergo the shaping procedure, as described above.

While various embodiments of the innovation have been particularly shown and described, it will be understood by those skilled in the art that various changes in form and details may be made therein without departing from the spirit and scope of the innovation as defined by the appended claims.

What is claimed is:

1. A saw blade, comprising:
a saw blade body;
at least one raker tooth carried by the saw blade body, the at least one raker tooth having a longitudinal axis that is substantially aligned with a longitudinal axis of the saw blade body;
at least one set tooth carried by the saw blade body, the at least one set tooth defining a set angle along a first direction relative to the longitudinal axis of the saw blade body; and
a cutting element carried by the at least one set tooth, the cutting element defining a lateral contact portion having a contact face defining a face angle along a second direction relative to the longitudinal axis of the saw blade body, the second direction opposing the first direction;
wherein the angle of the contact face is less than the set angle of the at least one set tooth.

2. The saw blade of claim 1, wherein:
the at least one set tooth comprises a right set tooth defining a right set angle along the first direction relative to the longitudinal axis of the saw blade body; and
the cutting element defines a right lateral contact portion, the right lateral contact portion having a right contact face which defines a right face angle along the second direction relative to the longitudinal axis of the saw blade body.

3. The saw blade of claim 2, wherein the right set tooth defines a set angle between about 5° and 15° relative to the longitudinal axis of the saw blade body.

4. The saw blade of claim 2, wherein the right contact face defines a face angle between about 2° and 8° relative to the longitudinal axis of the saw blade body.

5. The saw blade of claim 2, wherein the right contact face of the right lateral contact portion further defines an angle relative to a lateral axis of the saw blade body, the lateral axis being substantially orthogonal to the longitudinal axis of the saw blade body.

6. The saw blade of claim 2, wherein the right set tooth defines a medial dress angle portion opposing the right contact face.

7. The saw blade of claim 1, wherein:
the at least one set tooth comprises a left set tooth defining a left set angle along the first direction relative to the longitudinal axis of the saw blade body; and
the cutting element defines a left lateral contact portion, the left lateral contact portion having a left contact face which defines a left face angle along the second direction relative to the longitudinal axis of the saw blade body.

8. The saw blade of claim 7, wherein the left set tooth defines a set angle between about 5° and 15° relative to the longitudinal axis of the saw blade body.

9. The saw blade of claim 7, wherein the left contact face defines a face angle between about 2° and 8° relative to the longitudinal axis of the saw blade body.

10. The saw blade of claim 7, wherein the left contact face of the left lateral contact portion defines an angle relative to a lateral axis of the saw blade body, the lateral axis being substantially orthogonal to the longitudinal axis of the saw blade body.

11. The saw blade of claim 2, wherein the left set tooth defines a medial dress angle portion opposing the left contact face.

12. A saw blade, comprising:
a saw blade body;
at least one raker tooth carried by the saw blade body, the at least one raker tooth having a longitudinal axis that is substantially aligned with a longitudinal axis of the saw blade body;
at least one right set tooth carried by the saw blade body, the at least one right set tooth defining a right set angle along a first direction relative to the longitudinal axis of the saw blade body;
a cutting element carried by the at least one right set tooth, the cutting element defining a right lateral contact portion having a right contact face defining a right face angle along a second direction relative to the longitudinal axis of the saw blade body, the second direction opposing the first direction, wherein the angle of the right contact face is less than the right set angle of the at least one right set tooth;
at least one left set tooth carried by the saw blade body, the at least one left set tooth defining a left set angle along the second direction relative to the longitudinal axis of the saw blade body;
a cutting element carried by the at least one left set tooth, the cutting element defining a left lateral contact portion having a left contact face defining a left face angle along the first direction relative to the longitudinal axis of the saw blade body, wherein the angle of the left contact face is less than the left set angle of the at least one left set tooth.

13. The saw blade of claim 12, wherein the right set tooth defines a set angle between about 5° and 15° relative to the longitudinal axis of the saw blade body.

14. The saw blade of claim 12, wherein the right contact face defines a face angle between about 2° and 8° relative to the longitudinal axis of the saw blade body.

15. The saw blade of claim 12, wherein the right contact face of the right lateral contact portion further defines an angle relative to a lateral axis of the saw blade body, the lateral axis being substantially orthogonal to the longitudinal axis of the saw blade body.

16. The saw blade of claim 12, wherein the right set tooth defines a medial dress angle portion opposing the right contact face.

17. The saw blade of claim 12, wherein the left set tooth defines a set angle between about 5° and 15° relative to the longitudinal axis of the saw blade body.

18. The saw blade of claim 12, wherein the left contact face defines a face angle between about 2° and 8° relative to the longitudinal axis of the saw blade body.

19. The saw blade of claim 12, wherein the left contact face of the left lateral contact portion defines an angle relative to a lateral axis of the saw blade body, the lateral axis being substantially orthogonal to the longitudinal axis of the saw blade body.

20. The saw blade of claim 12, wherein the left set tooth defines a medial dress angle portion opposing the left contact face.
